(19) United States
(12) Patent Application Publication
(10) Pub. No.: US 2016/0249631 A1
(43) Pub. Date: Sep. 1, 2016

(54) FORTIFIED FOOD COMPOSITION

(71) Applicant: NESTEC S.A., Vevey (CH)

(72) Inventors: Clemence Maurin, Annecy (FR); Celine Barrail, Chexbres (CH)

(21) Appl. No.: 15/027,515

(22) PCT Filed: Oct. 10, 2014
(86) PCT No.: PCT/EP2014/071816

§ 371 Date: Apr. 6, 2016

(30) Foreign Application Priority Data
Oct. 11, 2013 (EP) 13188368.8

(51) Int. Cl. A23C 9/152; A23G 1/56; A23C 9/156; A23C 9/158

(52) U.S. Cl. CPC A23C 9/1522; A23C 9/158; A23G 1/56; A23C 9/156; A23L 1/303; A23L 1/304; A23V 2002/00

(57) ABSTRACT

The present invention relates generally to supporting the optimal growth and development of children through nutrition. In particular, the present invention relates to a composition containing a specific vitamin and mineral mix that—in combination with milk—is ideally suited to complement the goodness of milk, for example at breakfast. For instance, the composition comprises vitamin D, iron, vitamin C, zinc, magnesium, vitamin B1, and optionally vitamin A.

### TECHNICAL FIELD

The present invention relates generally to supporting the optimal growth and development of children through nutrition. In particular, the present invention relates to a composition containing a specific vitamin and mineral mix that—in combination with milk—is ideally suited to complement the goodness of milk, for example at breakfast.

### BACKGROUND OF THE INVENTION

As children grow, they develop new and exciting abilities that allow them to further explore the world and become an active member of society. The accompanying changes in the child's body are dramatic and need to be supported by proper nutrition, an active lifestyle, and a caring social environment. Proper growth and development of their children is a key concern of parents.

To assist in proper nutrition of children in pre-school to school age, several nutritional offers are on the market today. Many nutritional supplements, e.g. in tablet form or gummi bear form are offered. There is, however, the risk of overdosing, if these nutritional supplements are consumed in abundance.

Further, such nutritional supplements are often formulated to cover the needs of e.g. certain vitamins and mineral for a day, not considering, that they only represent a part of the daily diet. Consuming calcium supplementation and consuming a lot of yoghurt or milk at the same time could again lead to calcium overdosing.

Further, a lot of beneficial vitamins and minerals have an unpleasant taste profiles. Nutritional products that are supplemented with such compounds are consequently often less preferred.

Supplementation, however, can only be effective, if the children like the product and consequently consume it.

U.S. Pat. No. 6,030,650 A relates to a complete nutritional milk composition fortified with vitamins and minerals, such as flavored milk, ice cream, frozen yogurt, or yogurt. US 2003/0194468 A1 relates to an acidified nutritionally fortified cultured dairy product, such as a beverage or yogurt. CA 2256133 A1 relates to a drinking fluid fortified with vitamins and minerals. US 2004/0082536 A1 relates to a multi-vitamin and mineral supplement tailored to men, post-menopausal women, pre-menopausal women and athletes. US 2008/0286416 A1 and WO 03/065816 A1 relate to supplements for human milk specially adapted for the feeding of preterm infants or low birth weight infants. US 2006/0083824 A1 relates to nutritional supplements for glucose intolerant individuals. DE 20 2009 006144 U1 relates to a mix of aminoacids, vitamins and minerals.

It would therefore be desirable to have available a composition that allows it to optimally support growth and development of children, while avoiding at least some of the disadvantages of the state of the art

Any reference to prior art documents in this specification is not to be considered an admission that such prior art is widely known or forms part of the common general knowledge in the field.

### SUMMARY OF THE INVENTION

The object of the present invention was to improve the state of the art and in particular to provide a nutritional solution that allows it to optimally support growth and development of children while avoiding overdosing and unpleasant off-tastes, or to at least provide a useful alternative.

The inventors were surprised to see that the object of the present invention could be achieved by the subject matter of the independent claims. The dependent claims further develop the idea of the present invention.

In particular, the inventors were able to provide a specific vitamin and mineral mix that was able to ideally complement the goodness of milk and is well-liked by consumers, in particular by children.

This was surprising as magnesium and vitamin C, for example, have a sour taste, or as the taste of zinc and vitamin B1 are also generally perceived as unpleasant.

The composition of the present invention provides a specific composition of vitamins and minerals that complement the goodness of milk, and allows it to provide children with what they need to grow and develop.

Accordingly, the present invention provides a dry powder composition comprising cocoa and sugar, wherein the cocoa:sugar weight ratio ranges from 20:80 to 30:70, wherein the composition contains per 100 g: 19-21 g cacao, 75-80 g sugar, 8-14 μg vitamin D, 63-72 mg vitamin C, 0.6-0.8 mg vitamine B1, 245-265 mg magnesium, 15-20 mg iron, and 6-9 mg zinc.

Growth is a phenomenon associated with increases in body tissue mass and height. Childhood and adolescence are a critical period for growth, especially bone growth and the achievement of peak bone mass, providing an important opportunity to reduce the risk of osteoporosis in later life. Appropriate nutrition and regular physical activity are important factors to ensure normal growth. Several micronutrients are required in order to support the activity of bone forming cells on the inside (organic matrix), which promotes stronger bones outside (inorganic matrix). Calcium and vitamin D are the most studied of these micronutrients. The composition of the present invention contains vitamin D, which plays a key role in bone metabolism by maintaining calcium and phosphate balance in the body. Vitamin D increases both the intestinal absorption and re-absorption of calcium in the kidney thus increasing calcium availability for the bones (Weaver (2007) J. Bone & Mineral Res. 22 (2): 45-49.). The composition of the present invention also contains vitamin C, which contributes to normal collagen formation and normal function of bones, as well as magnesium, which contributes to the maintenance of normal bones.

As such the composition of the present invention is an ideal complement to milk which provides the necessary calcium, for example.

Development is a physiological concept indicating the progressive acquisition of the organ specific functions. The brain starts to develop within the first days of conception and continues to grow and develop throughout childhood and beyond. Childhood is a period of particularly rapid brain growth, which results in the emergence of different cognitive functions such as memory, concentration and language. Nutrition plays a key role in cognitive functioning, learning and behavior but it is especially critical during periods of rapid brain growth. Indeed poor nutrition has been found to impact neurodevelopment, cognition and behavior. Various studies investigated the effect of supplementation with different combinations of vitamins and minerals on cognition. Whilst differences in the type, duration and dose of supplementation and the methodologies used resulted in inconsistencies in the effects observed and types of cognitive functions being impacted, there is evidence that iron and zinc, micronutrients present in the composition of the present invention, positively influence cognitive function especially in cases of inadequate nutrition. The composition of the present invention contains iron that plays an important role in various processes in the brain, including the production of myelin, and the synthesis and breakdown of neurotransmitters such as dopamine, which is important for cognitive functions such as attention and executive function. The composition of the present invention also contains zinc, a critical nutrient for the development of the central nervous system. Zinc is involved in neurotransmission associated with memory function. The composition also contains magnesium, thiamin (vitamin B1), and vitamin C, which all support normal function of the nervous system.

The present invention also relates to a beverage comprising the composition of the present invention.

The present invention further relates to the composition of the present invention for use in treating or preventing an impaired growth and development in children, and/or in supporting a healthy growth and development in children.

Further, the composition of the present invention may be for use in complementing the goodness of milk.

As used in this specification, the words “comprises”, “comprising”, and similar words, are not to be interpreted in an exclusive or exhaustive sense. In other words, they are intended to mean “including, but not limited to”.

### BRIEF DESCRIPTION OF THE DRAWINGS

FIG. 1 shows photos taken during the consumer test described in the example.

FIG. 2 shows a detailed analysis of the taste profile of a regular chocolate milk recipe (basic recipe) and of a fortified chocolate milk recipe (basic recipe+vitamin/mineral mix) containing the vitamin/mineral mix of the present invention.

### DETAILED DESCRIPTION OF THE INVENTION

Consequently the present invention relates in part to a dry powder composition comprising cocoa and sugar, wherein the cocoa:sugar weight ratio ranges from 20:80 to 30:70, wherein the composition contains per 100 g: 19-21 g cacao, 75-80 g sugar, 8-14 μg vitamin D, 63-72 mg vitamin C, 0.6-0.8 mg vitamin B1, 245-265 mg magnesium, 15-20 mg iron, and 6-9 mg zinc.

For example, the composition of the present invention does not contain added calcium, and/or does not contain vitamin E. “Added calcium” is a calcium salt provided as an ingredient in the composition. Examples of added calcium salts include calcium carbonate, calcium phosphate, calcium citrate, calcium lactate, and other calcium inorganic or organic salts. However, the composition of the present invention may contain calcium as a natural constituent of one of its food ingredient, such as cocoa. Calcium may also be found in milk, when the dry composition is reconstituted in milk.

The composition of the present invention may be edible, that is approved for human or animal consumption. Further, the composition of the present invention may be soluble in water or in milk.

Advantageously, the composition of the present invention—if added to milk—ideally complements the vitamins and minerals present in milk, so that the resulting beverage optimally supports a healthy growth and development in children.

For the purpose of the present invention, children may be between 4 and 14 years old, for example between 4 and 12 years old, or between 6 and 12 years old. The dry powder composition is not adapted for infants, i.e. children younger than 3 years old. In particular, the dry powder composition is not adapted for toddlers or babies. For instance, the dry powder composition is not a human milk supplement.

Children may be reluctant, or may find it difficult, to swallow a drug-like composition, such as a pill, a tablet, an effervescent tablet, a sachet, and the like. The composition of the present invention is not a drug-like composition.

To ensure that the composition is well liked by children, for example, the composition may further comprise sugar, e.g., as energy source for brain and body and a flavoring compound. Natural flavoring compounds are preferred.

The dry composition of the present invention contains sugar and cocoa. The ratio of sugar and cocoa in the composition in the present invention may be in the range of from 80:20 to 70:30. For example, the composition of the present invention may further contain sugar and cocoa in a sugar:cocoa weight ratio ranging from 79:21 to 75:25.

To ensure that the composition can be easily stored, for example without refrigeration, the composition is provided in a dry powder form. Possible dry powder forms are granulated formats or agglomerated formats for example. Granulates and agglomerates have the advantage of being easy to handle with low likelihood of spillage or dust formation.

As mentioned, the dry powder composition comprises per 100 g dry composition 19-21 g cocoa, 75-80 g sugar, 8-14 μg vitamin D, 63-72 mg vitamin C, 0.6-0.8 mg vitamine B1, 245-265 mg magnesium, 15-20 mg iron, and 6-9 mg zinc. The composition, for example, comprises per 100 g dry composition 20-36 mg calcium, and calcium is not added calcium.

The composition of the present invention may further comprise cinnamon powder, vanillin, soya lecithin, and/or maltodextrin. For example, 100 g of the dry composition may further comprise from 20 to 25 mg cinnamon powder, from 60 to 70 mg vanillin, from 1.00 to 1.15 g soya lecithin, and/or from 50 to 60 mg maltodextrin.

The composition of the present invention in dry form may be to be reconstituted in a drinkable liquid, such as milk or water.

Due to the optimal complementation of milk, milk is preferred.

A typical serving size may be 200 mL of liquid to which the composition of the present invention is added.

Typically, 1 to 3 teaspoons of the composition of the present invention may be added to 200 mL milk. For example, 2 teaspoons of the composition may be added to 200 mL milk. In grams, 2 teaspoons of the composition correspond to from about 12.5 to about 14.5 g, for example about 13.5 g.

Accordingly, 6.25 to 7.25 g of the composition may be to be added to 100 mL milk, 31.25 to 36.25 g of the composition may be added to 500 mL of milk, or 62.5 to 72.5 g of the composition may be added to 1 L of milk.

Serving size is two teaspoons of the dry composition (13.5 g) per 200 mL milk. For instance, when 13.5 g of dry composition is added to 200 mL milk, a composition comprising from 1.0 to 2.0 μg vitamin D, from 2.1 to 4.2 mg iron, from 9 to 18 mg vitamin C, from 2.25 to 4.5 mg zinc, from 45 to 90 mg magnesium, from 0.21 to 0.42 mg vitamin B1, may be obtained.

Within the context of this invention “milk” refers to cow milk, goat milk, sheep milk, mare milk, or donkey milk. Preferably, “milk” is cow milk. Milk may be full fat milk, semi-skimmed milk or skimmed milk. For example, the milk may have a 3.5% fat content, 2.5% fat content or 1.5% fat content.

In one embodiment of the present invention, the milk is semi-skimmed milk.

The composition of the present invention can be consumed by anybody. However, the vitamin and mineral composition of the present invention was specifically designed for children. Hence, the composition of the present invention may be to be administrated to children.

The composition of the present invention can be consumed at any time. However, it was specifically designed to be consumed at breakfast to give the child a good and nutritionally valuable start into the day. Hence, the composition of the present invention may be to be consumed as part of breakfast.

For a maximal effect in terms of supporting the optimal growth and development of children the composition of the present invention should be consumed regularly, for example at least 3 times a week, at least 5 times a week, or at least once daily.

The present invention further relates to a beverage comprising the composition as described above.

The beverage of the present invention may further contain milk or be dairy-based. “Dairy based” means having about the consistency and mouthfeel of milk and at least 60% of the milk macronutrients. Often dairy based compositions contain typical milk proteins, but have some constituents of milk replaced. As such, milk fats may be replaced by vegetable fats, for example. Examples of dairy based compositions are infant formulas, follow-up formulas or growing-up milks.

Embodiments of the present invention further relate to a beverage consisting of the composition of the present invention and milk.

The composition of the present invention may be for use in treating or preventing an impaired growth and development in children. The composition of the present invention may further be for use in supporting a healthy growth and development in children.

Hence, the subject matter of the present invention further relates to the use of the composition of the present invention for the preparation of a beverage to treat or prevent an impaired growth and development in children. The subject matter of the present invention also relates to the use of the composition of the present invention for the preparation of a beverage to support a healthy growth and development in children.

Notably, the composition of the present invention contains

Vitamin D, which contributes to the maintenance of normal bones and teeth.

Vitamin D, which contributes to normal absorption (or utilization) of calcium and phosphorus and maintenance of normal blood calcium concentration.

Zinc and iron, which contribute to normal cognitive function.

Iron, which contributes to normal cognitive development of children.

Magnesium, thiamin (vitamin B1) and vitamin C which contribute to the normal function of the nervous system.

Vitamin C, which contributes to normal collagen formation.

Vitamin C, which contributes to the normal function of bones.

Magnesium, which contributes to the maintenance of normal bones.

Optionally, Vitamin A which contributes to normal cell differentiation.

Hence the composition of the present invention may be for use in treating or preventing vitamin D, iron, vitamin C, zinc, magnesium, vitamin B1, and/or vitamin A deficiencies.

Finally, the composition in accordance with the present invention may be for use in complementing the goodness of milk.

Those skilled in the art will understand that they can freely combine all features of the present invention disclosed herein. In particular, features described for the composition of the present invention may be combined with the intended use of the present invention and vice versa. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred to in this specification. Further advantages and features of the present invention are apparent from the figures and non-limiting examples.

### EXAMPLE

Consumer preference of a regular chocolate powder was tested against the same chocolate powder containing the vitamin and minerals composition of the present invention (fortified chocolate powder).

The products were packed in white cans containing 100 gr of the compositions to be tested. The cans were labeled in a way that the consumers could not identify which can contained the fortified chocolate powder and which can contained regular chocolate powder.

154 children were asked to prepare their chocolate drink by adding the compositions to be tested to milk. The consumer test group consisted of 49% girls and 51% boys, 52% 7 to 9 yrs old and 48% 10 to 12 yrs old. All children were regular consumers of chocolate drinks at breakfast and/or in the afternoon, at least 3 times a week (with cold or hot milk).

After testing the products, the children were interviewed by means of face-to-face interviews.

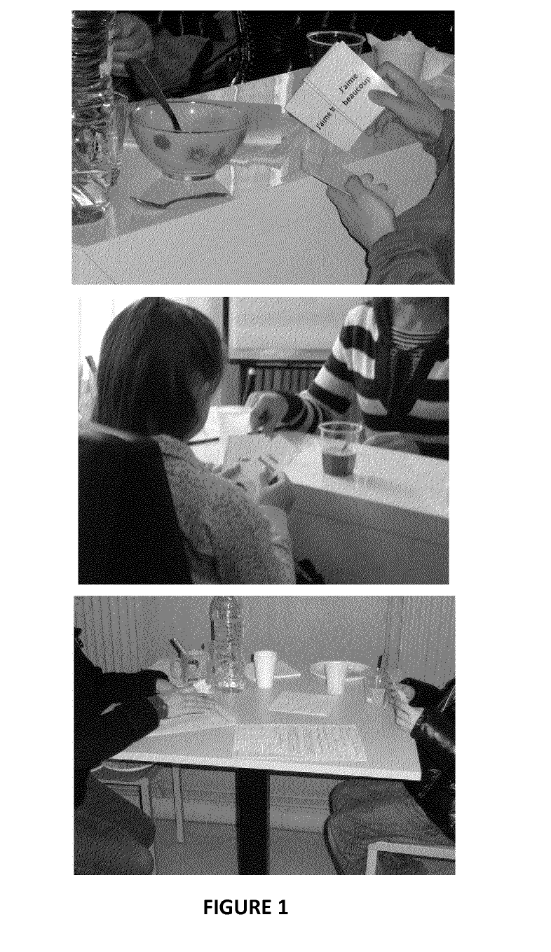

This way of data collection ensures a complete uniformity of the tasting conditions. FIG. 1 shows pictures taken during the consumer test.

A summary of the spontaneous comments made by consumers after testing the regular chocolate recipe and the fortified chocolate recipe containing the vitamin/mineral mix of the present invention, is provided in the table below, which shows the results of this study.

| Summary of spontaneous | Regular chocolate | Fortified chocolate |
|---|---|---|
| comments | recipe | recipe |
| Positive comments | 93 | 97 |
| Negative comments | 27 | 24 |
| Difference (Positive − Negative) | 66 | 73 |
| Exclusively positive | 73 | 75 |
| Exclusively negative | 6 | 3 |
| Mixed | 21 | 22 |

| | |
|---|---|
| Base | 154 |

Clearly, the study shows that the addition of the vitamin and mineral mix of the present invention does not have a negative impact on taste of the final product.

From the spontaneous first comment even a small positive impact can be seen, although not statistically significant.

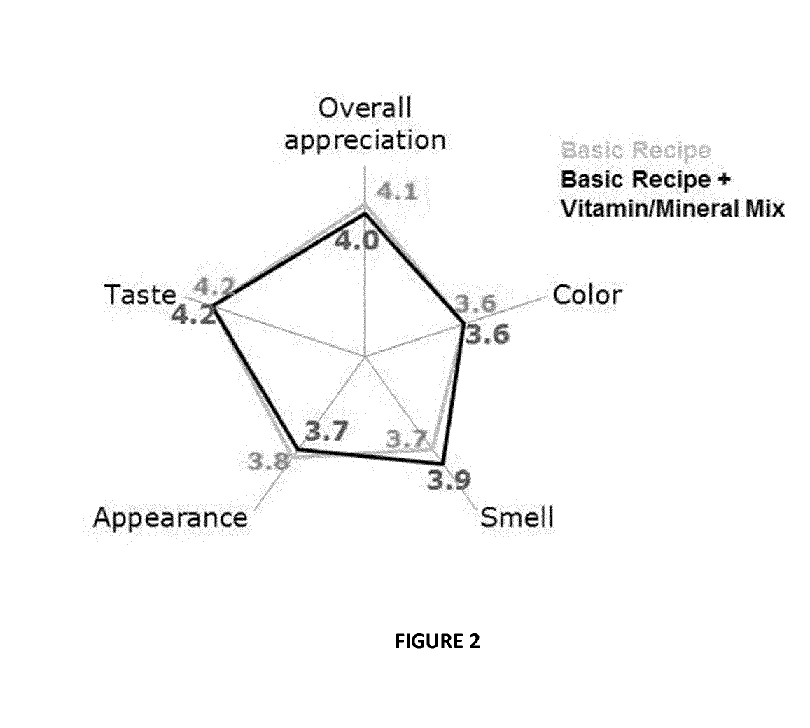

FIG. 2 shows a more detailed analysis of the consumer test in the form of a spider web diagram. Also here no statistically significant difference can be seen between the two compositions.

Consequently, the addition of the vitamin mineral mix of the present invention allows it to improve the nutritional value, e.g., of a chocolate milk drink, significantly without having a negative impact on taste.

1. Dry powder composition comprising cocoa and sugar, wherein the cocoa:sugar weight ratio are from 20:80 to 30:70, wherein the composition contains per 100 g: 19-21 g cacao, 75-80 g sugar, 8-14 μg vitamin D, 63-72 mg vitamin C, 0.6-0.8 mg vitamine B1, 245-265 mg magnesium, 15-20 mg iron, and 6-9 mg zinc.

2. Composition according to claim 1, comprising per 100 g: from 20 to 25 mg cinnamon powder, from 60 to 70 mg vanillin, from 1.00 to 1.15 g soya lecithin, and/or from 50 to 60 mg maltodextrin.

3. Composition according to claim 1, wherein the composition is granulated or agglomerated.

4. Composition according to claim 1, wherein the composition is to be reconstituted in milk.

5. Composition according to claim 4, wherein 6.25 to 7.25 g of the composition may be added per 100 mL milk.

6. Composition according to claim 1, wherein the composition is designed to be administered to children.

7. Composition according to claim 1, wherein the composition is designed to be consumed as part of breakfast.

8. Composition according to claim 1, wherein the composition is designed to be consumed at least once daily.

9. A method for treating or preventing an impaired growth and development in children comprising administering a composition comprising cocoa and sugar, wherein the cocoa:sugar weight ratio are from 20:80 to 30:70, wherein the composition contains per 100 g: 19-21 g cacao, 75-80 g sugar, 8-14 μg vitamin D, 63-72 mg vitamin C, 0.6-0.8 mg vitamine B1, 245-265 mg magnesium, 15-20 mg iron, and 6-9 mg zinc to an individual in need of same.

10. A method for treating or preventing vitamin D, iron, vitamin C, zinc, magnesium, and/or vitamin B1, deficiencies comprising administering a composition comprising cocoa and sugar, wherein the cocoa:sugar weight ratio are from 20:80 to 30:70, wherein the composition contains per 100 g: 19-21 g cacao, 75-80 g sugar, 8-14 μg vitamin D, 63-72 mg vitamin C, 0.6-0.8 mg vitamine B1, 245-265 mg magnesium, 15-20 mg iron, and 6-9 mg zinc to an individual in need of same.

11. A method for use in supporting a healthy growth and development in children comprising administering a composition comprising cocoa and sugar, wherein the cocoa:sugar weight ratio are from 20:80 to 30:70, wherein the composition contains per 100 g: 19-21 g cacao, 75-80 g sugar, 8-14 μg vitamin D, 63-72 mg vitamin C, 0.6-0.8 mg vitamine B1, 245-265 mg magnesium, 15-20 mg iron, and 6-9 mg zinc to an individual in need of same.

12. A method for complementing the goodness of milk comprising providing milk and a composition comprising cocoa and sugar, wherein the cocoa:sugar weight ratio are from 20:80 to 30:70, wherein the composition contains per 100 g: 19-21 g cacao, 75-80 g sugar, 8-14 μg vitamin D, 63-72 mg vitamin C, 0.6-0.8 mg vitamine B1, 245-265 mg magnesium, 15-20 mg iron, and 6-9 mg zinc.
